(19) United States
(12) Patent Application Publication
(10) Pub. No.: US 2010/0217525 A1
(43) Pub. Date: Aug. 26, 2010

(54) System and Method for Delivering Sponsored Landmark and Location Labels

(76) Inventors: Simon P. King, Berkeley, CA (US); Chris W. Higgins, Portland, OR (US); Mare Davis, San Francisco, CA (US)

Correspondence Address: STATTLER - SUH PC, 60 SOUTH MARKET STREET, SUITE 480, SAN JOSE, CA, 95113, US

(21) Appl. No.: 12/392,678

(22) Filed: Feb. 25, 2009

(51) Int. Cl. G06Q 30/00; G01C 21/00

(52) U.S. Cl. 701/300; 705/10; 705/14.57

(57) ABSTRACT

A method for constructing geo-location service replies (e.g. “You are near Bob's Café”, or “Proceed one block north to Bob's Café”) based on landmark-related relevance factors (e.g. if the user's location is close to a known landmark or sponsored location) to serve to a client terminal (e.g. a user's a mobile telephone, a smart phone, a GPS terminal). The system receives a user's geo-location service request (e.g. “Where am I”), and proceeds to construct one or more response candidates to service the user's geo-location service request. Candidate replies are then scored based on relevance factors (e.g. does the candidate location relate to the user's recent geo-service queries, is there a sponsored landmark in general proximity, etc), and high scoring geo-service replies are sent to the user's client terminal. In some cases, more than one relevance factor is considered (e.g. proximity relevance, visibility relevance, familiarity relevance, etc).

### FIELD OF THE INVENTION

The present invention is directed towards selecting advertisements based on landmark and location data.

### BACKGROUND OF THE INVENTION

Many location systems (e.g. a GPS system, a vehicle navigation system) operate using a human-readable textual representation of user location, for example, a street address (e.g. 1200 Main Street). However few location systems can identify a user's current address correctly. This is partly due to inaccuracies in location sensing and partly due to lack of precision or completeness in the underlying geo-data used in the reverse geo-coding techniques. As a consequence, some location systems report merely that a user is at some latitude and longitude (e.g. 43.1234 Latitude, 21.2345 Longitude) or may report that the user is at some ‘fake’ address’ (e.g. 1200 Main Street, where 1200 Main street does not in fact exist), or may report that the user is near a particular location as opposed to at a particular location. For example if a user ‘A’ is at a longitude and latitude reported in the underlying geo-data to be at the same longitude and latitude as, say the Empire State Building, some location systems report user ‘A’ is near the Empire State Building. In most urban environments a user will often be near a large number of businesses or landmarks, thus a location systems report that lists the landmarks near to the user's location, or within some proximity of the user's location might report too much information. Traditional filtering techniques, including filtering techniques employed within the so called “geo-model” may reduce the volume of the location information presented to the user, however making a ‘best’ selection of a landmark to present to the user is desired. This invention addresses ranking landmarks or businesses within an area of uncertainty, and the disclosure presents techniques for use in constructing and ranking sponsored landmark and location labels to result in a set of ‘best’ landmark to report. Further, combining sponsored content with the techniques disclosed herein may result in improvements in the performance of a sponsor's campaigns (e.g. number of impressions, number of clicks, number of promotional downloads, actual sales, etc), and hence revenue might be increased.

Other features and advantages of the present invention will be apparent from the accompanying drawings, and from the detailed description that follows below.

### SUMMARY OF THE INVENTION

A method for constructing geo-location service replies (e.g. “You are near Bob's Café”, or “Proceed one block north to Bob's Café”) based on landmark-related relevance factors (e.g. if the user's location is close to a known landmark or sponsored location) to serve to a client terminal (e.g. a user's a mobile telephone, a smart phone, a GPS terminal). The system receives a user's geo-location service request (e.g. “Where am I”), and proceeds to construct one or more response candidates to service the user's geo-location service request. Candidate replies are then scored based on relevance factors (e.g. does the candidate location relate to the user's recent geo-service queries, is there a sponsored landmark in general proximity, etc), and high scoring geo-service replies are sent to the user's client terminal. In some cases, more than one relevance factor is considered (e.g. proximity relevance, visibility relevance, familiarity relevance, etc).

### BRIEF DESCRIPTION OF THE DRAWINGS

The novel features of the invention are set forth in the appended claims. However, for purpose of explanation, several embodiments of the invention are set forth in the following figures.

FIG. 1A shows schematic representation of a system, including a network environment in which some embodiments operate;

FIG. 1B is a flowchart of a method for responding to a geo-location request, according to some embodiments;

FIGS. 2A-2D are flowcharts of methods for responding to a geo-location request, according to some embodiments;

FIG. 3 illustrates a conceptual model of one embodiment of a W4 engine;

FIG. 4 illustrates the use of sliders to influence quantitative scoring, according to some embodiments;

FIG. 5 illustrates possible analysis components of one embodiment of a W4;

FIG. 6 illustrates one embodiment of a W4 engine showing different components within the sub-engines shown in FIG. 5;

FIG. 7 is a diagrammatic representation of a machine in the exemplary form of a computer system, within which a set of instructions may be executed;

FIG. 8 is a diagrammatic representation of several computer systems in the exemplary form of a client server network, within which environment a communication protocol may be executed.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

Mobile phones and other mobile devices have proliferated to the extent that most people in many developed countries now carry with them at least one mobile device. Moreover, such mobile devices are capable of geo-location awareness. Accordingly, demand for so-called geo-location services continues to increase, and mobile users (henceforth “user”, or “users”) are expecting more and more from such services. While the aforementioned mobile devices or any device declared by the user to be a location platform (“UDLP”), together with network service providers, are able to identify a user's location by longitude and latitude with some accuracy (e.g. within a radius of 10 meters or so). However, merely knowing a longitude and latitude is of limited help to a user; a landmark name or photo is likely to be much more useful to a user than a longitude and latitude. However, in most urban environments, and at any given moment in time, a user will be near many landmarks and businesses—all of them located within very close distances. Merely listing the candidates (e.g. in alphabetical order, or by category) might not be helpful to the user either as mobile devices can only reasonably display a relatively small amount of information at any one moment in time.

Embodiments of the invention disclosed herein consider relevance to the user, possibly including relevance factors that correlate to business locations (e.g. “Bob's Café”). Such relevance (e.g. spatial relevance, temporal relevance, social relevance, topical relevance, keywords, or other relevance factors) allows advertisers or business owners to pay to have their business featured within the context of a geo-location service, and such advertisers might want to associate their brand with a nearby landmark. Of course techniques are provided herein to rank or score relevance factors and other factors, thus rendering within the system a set of reasoned choices from among a larger set of many nearby landmarks—and doing so without greatly degrading the accuracy of the geo-service information returned to the user. As a result, real world businesses pay to associate relevant reference location labels for nearby locations. This is similar to sponsored search results for a given query in that real world businesses pay to associate relevant advertisements to search query results. In addition to returning labels and sponsored labels, the system can return directions to a sponsored landmark from an arbitrary location (e.g. “proceed two blocks north from Coit Tower to reach Bob's Café”). Thus, end users of the system gain the advantage of having reliable human comprehensible location labels, while at the same time advertisers gain a new way to reach “qualified prospects” (e.g. a person looking for a coffee shop and standing directly in front of Bob's Café, or merely a person standing directly in front of Bob's Café). Even more utility is garnered by operators of the geo-coding services as a result of a better user experience.

Embodiments of the present invention create new forms of geo-location services and sponsored advertising in conjunction with reverse geo-coding (location) requests from UDLPs (henceforth “user device” or “user devices”). Typically the location of a user might be made available to a network. Application servers on the network can then use location information in conjunction with other information to present highly relevant information back to the user. Specifically, the information returned back to the user might include common names of well-known landmarks (e.g. the “Empire State Building”) or names of well-recognized businesses (e.g. “Starbucks”). However, the techniques disclosed herein provides an alternative model for orienting users based upon relevance factor matching, possibly in conjunction with real-time bidding marketplaces. The real-time bidding marketplaces organized as electronic bid phrase auctions might include any combination of local and national advertisers for both landmarks and sponsored location labels. Moreover, techniques for orienting a user might include specialized labels (e.g. text labels, audio labels, video labels, media labels, text labels translated into any one or more languages, or images, sounds, video, and/or other media) and the labels selected for orienting a user might be selected from among generic labels (e.g. the “Empire State Building”) and/or from sponsored labels (e.g. the “Starbucks at the Broadway Entrance of the Empire State Building”), and delivered to a user in a targeted fashion.

Of course any number of techniques for targeting a user might be used, including user preferences (e.g. preferences to text messages over email), user permissions (e.g. user permission to track location, user permission to use previously captured user profile data or user behavior data), and/or any other user information for that matter. Similarly any number of techniques for delivering information to a user might be used, including text messaging, and text pages, pushed media, turn-by-turn navigation instructions, links, web page displays, streaming media, interactive media, etc).

Singly and in combination, the techniques disclosed herein connect users to a useful geo-locating schema based upon real-world landmarks and real-world business, and other real-world entities (henceforth, “RWE”, or “RWEs”) such that users can more easily and more efficiently utilize geo-coding information provided by and to real-world UDLPs. Some embodiments of the invention include a sponsored-search advertising marketplace system, complete with advertiser account and campaign management functionality (e.g. a max bid system for sponsorship events). Other embodiments make information from (or related to) a user's geo-location request available for dynamically constructing or otherwise labeling the content of the response to the geo-location request.

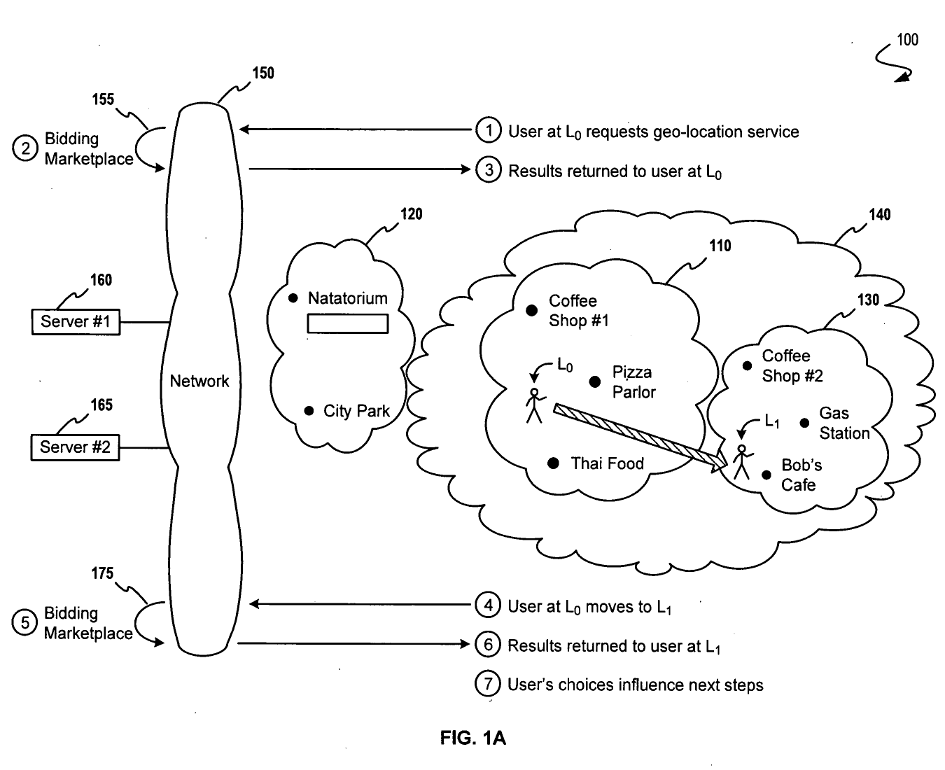

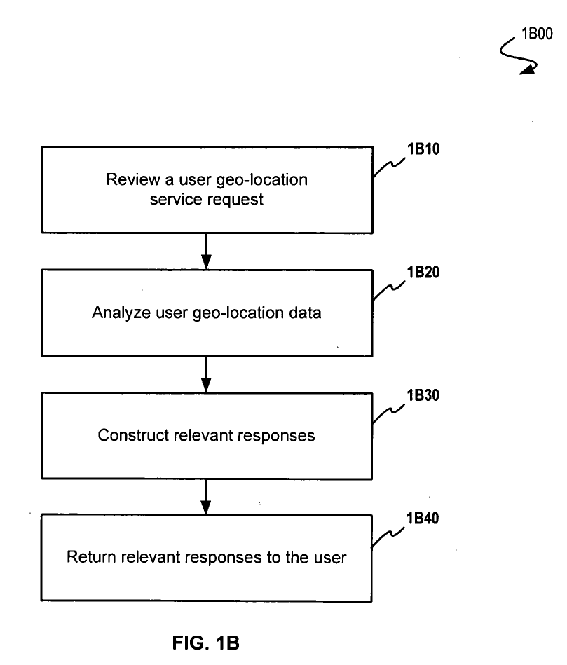

The schematic of FIG. 1A shows a possible scenario involving a mobile user and the user's interaction with a network providing one or more services for delivering sponsored landmark and location labels. As shown, a pedestrian user located at location L₀, requests a geo-location service from the network 150. In response to the user's request, the network 150, analyses the user's geo-location relative to a database of landmarks and sponsored locations, such analysis possibly including one or more specialized servers 160, 165. Such analysis might also include operations for formation of a biding marketplace 155, and execution of a real-time auction. Once the network 150 returns information to the user, the user might make use of the returned information. Such information might include sponsored information, such as “You are across from the City Park Natatorium—brought to you by Mike's Sports Gear”. Or it might include non-sponsored geo-location information such as “You are on the eastern border of the City Park”. Depending on the density of the user's location might even include geo-information related to adjacent locations, such as “You are only two blocks from Bob's Café”. Following this scenario, the user walks to location L₁, (in the direction of Bob's Café), and again requests geo-location services. Again the network might form a new biding marketplace 175 based on the new geo-location, and might again execute a real-time auction. Such results, at least partially relevant to the geo-location L₁ are returned to the user. Such results might be generalized as in, “You are only one block from Bob's Café”, or it might be more specific to the user (e.g. “Get your favorite French roast coffee at Bob's Café”) or even user-customized, possibly including real-time, turn-by-turn directions to Bob's Café. Indeed, the aforementioned user-customized results might (or might not as discussed below) use any sort of information available from the user, the user's profile, the user's behaviors, or any other data used in the course of matching for relevance. The user continues to interact with the network, and the network responds so long as the user continues to make requests for geo-location services.

Now, considering in somewhat more detail the various characteristics of the system as described within the context of FIG. 1, one should note that the bidding marketplaces 155, 175 might be formed spontaneously upon the event of a user requesting a geo-service from a particular location. Even though there might be only a single winner (sponsor) of the spontaneous auction, that sponsor's advertisements are not necessarily selected. Other relevance factors criteria possibly considering a range of user data might be included in any filtering and scoring operations in order to resolve to a set of most relevant results (and not necessarily only results prescribed by the highest bidder) to return to the user. In some embodiments, the system operates agnostically with regard to a users profile or characteristics, (e.g. anonymous geo-coding), and in these cases all eligible advertisers are included in the marketplace for the sponsorship event.

The system and scenarios described above can be abstracted into a method as shown in FIG. 1B. The steps shown comprise (a) receiving a user's geo-location service request 1B10, (b) analyzing user geo-location data 1B20, (c) constructing relevant responses 1B30, and (d) returning relevant responses to the user 1B40.

In some embodiments, and as implied in operation 1B10, a geo-request comes in from a user (e.g. from a cell phone, or other UDLP), wherein a user requests a reply from a geo-coding service, and the system calculates the actual location via one or more techniques (e.g. via GPS, cell triangulation, etc.) to create a base location. Various techniques might then be applied to analyze the user's base geo-location 1B20. A geo-location generally results in a point location, with the precision attendant to the locating technique (e.g. via GPS, cell triangulation, etc), so generally the base location is expanded outward to encompass a broader geographic coverage, of course, broader might mean broader in the range of a fraction of the resolution of the geo-locating technique, or it might mean broader in the range of multiples of the resolution of the geo-locating technique. Expansion of the geographic coverage may continue outward until either an upwards area coverage limit is reached or until a sufficient number of advertisers associated with the covered area are populated into an initial candidate set of advertisers. Operation 1B30 constructs relevant responses to create a set of candidate responses, possibly including sponsored responses (e.g. “Just 50 feet to Bob's Café”) and/or non-sponsored responses (e.g. “You are 2 blocks east of the City Park”). Of course in the case that sufficient sponsors (advertisers) are populated in the initial candidate set of advertisers (i.e. in operation 1B20) then a spontaneous bidding marketplace might be formed using the user's geo-location as a bidding characteristic. Those skilled in the art will immediately recognize that a spontaneous marketplace can be formed, and bidding completed with a matter of seconds or fraction thereof. Once bidding is complete the advertisers are ranked according to a weighted distance, and may be further ranked based within a bid and past performance model to produce a winner (and possibly a list of runner ups) for that request/event. In operation 1B40, relevant results are returned to the user. Results returned to the user might include text, image, audio, video or any combination thereof, and might designate the users location as “near”, or “by”, or “around the corner from”, or “next to”, or “behind”, or “outside”, or “in front of”, “in between”, “across the street from”, “in”, “at”, “north of”, “south of”, “to the left of”, “to the right of”, etc. a business or landmark. The results might be stored in memory of a computer, or it might be stored in a cache or possibly in a non-volatile medium, or it might be stored in a message passed to the requesting user over a network or bus.

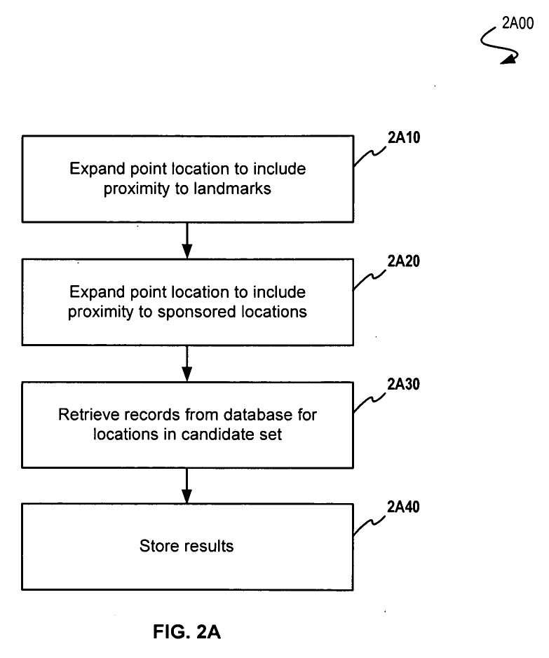

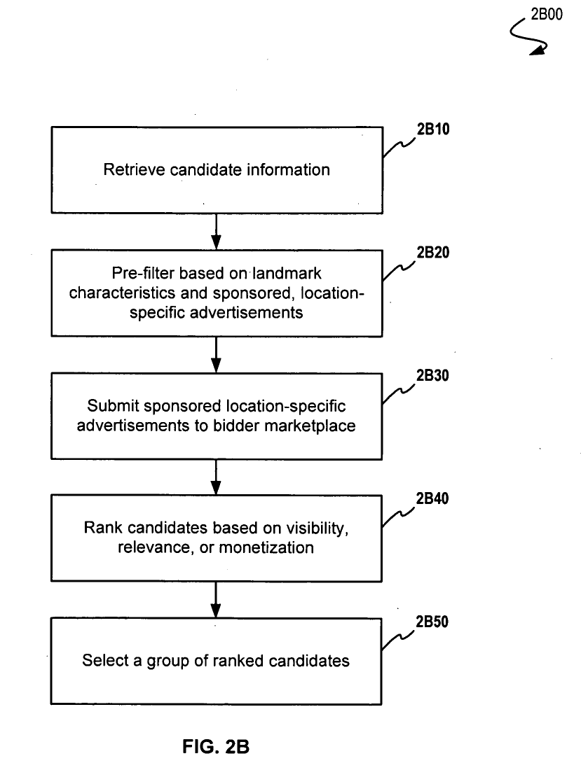

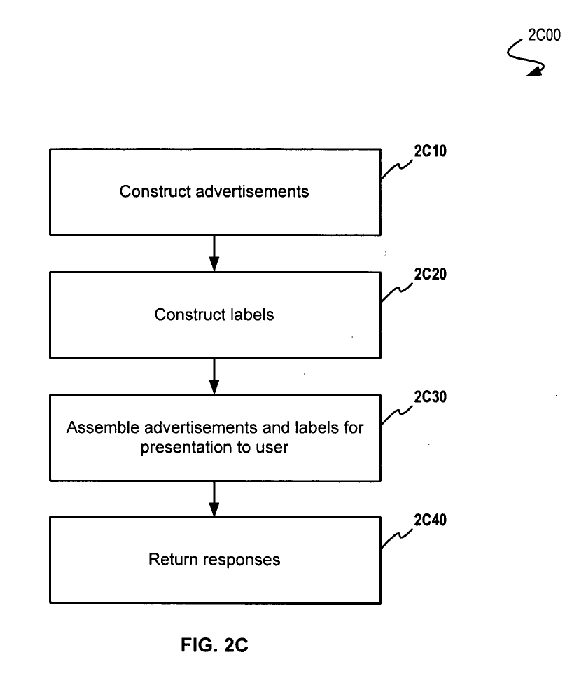

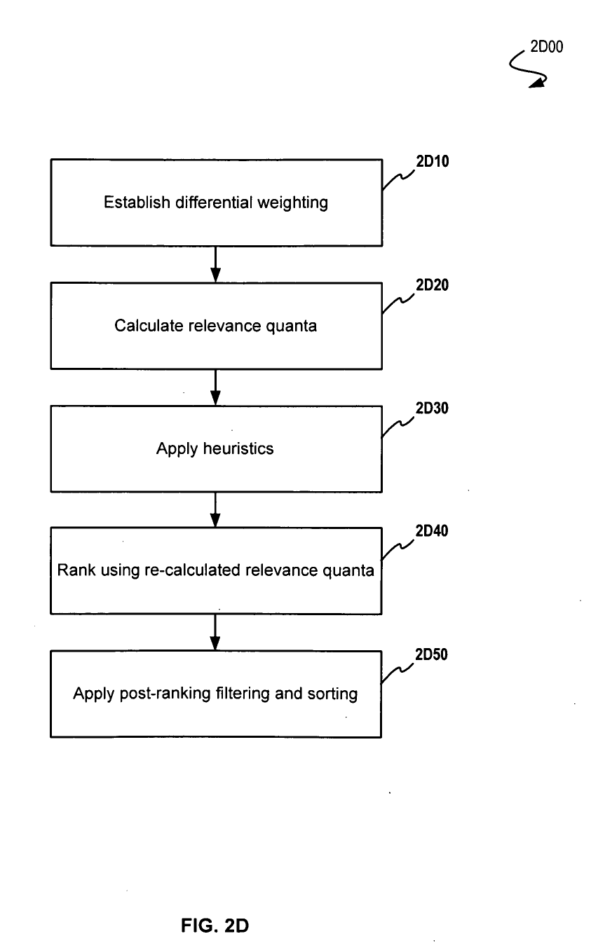

FIG. 2A presents a system 2A00 implementing a possible technique for analyzing user geo-location data. Of course the system 2A00 can be implemented in any of the contexts of FIGS. 1A-1B. As shown the operations of FIG. 2A might be executed sequentially, or they might be implemented in parallel, or some combination of sequential or parallel execution. As earlier indicated, since a geo-location generally results in a point location, with the precision depending from the locating technique (e.g. via GPS, cell triangulation, etc) generally the base location is expanded outward to encompass a somewhat broader geographic coverage. One possible technique for expanding about a point-geo-location is to expand radially from the point to include sufficient area to cover at least one additional landmark or labeled location. For example if the user's geo-location were at point L₀, the area might be expanded to include all of the landmarks and/or labeled locations as shown in area 110. Of course, such an area as defined by the geo-location points of the included landmarks might produce an irregular shape (as shown at area 110). In some cases, there might be a large number of landmarks and few or even zero sponsored (labeled) locations. Conversely, there might be a large number of sponsored locations and few or even zero common landmarks. Accordingly, separate operations 2A10 and 2A20 are defined such that a proximity (using a larger radius) can be defined to include at least one location of each type in a candidate set of locations. Conversely, in a high-density location, a proximity (using a smaller radius) can be defined to include sufficiently few locations of each type in a candidate set of locations. Having thus identified at least one location of each type, an operation 2A30 might retrieve database records pertaining to any/all of the locations in the candidate set. Such retrievals or a subset thereof might then be stored 2A40 for use by other operations. It should be emphasized that although there exist various services and databases that purvey location data, one technique for populating a location database as might be used in embodiments include data that is self-populated by sponsors or advertisers. The notion of self-population can be appreciated by recognizing that the mere act of defining a sponsorship or advertising campaign for use with the techniques described here might result in population of locations which are not only important to the sponsor/advertiser, but are not explicitly found in the aforementioned purveyed location data. For instance, a chain of coffee shops might publish a more up-to-date set of their store locations as sponsored locations than is readily available from a public data source such as a local Chamber of Commerce. Of course, it is possible that a landmark database could be populated entirely with sponsored locations, and in such a case the aforementioned purveyed location data might not be needed. Some sponsored landmarks will likely be businesses themselves, but in other cases a business may sponsor a well-known public landmark (e.g. “People's Park in Berkeley, across the street from Raleigh's Pub”). In the case of public landmarks, the system could learn the relative attention rank (popularity) of a particular landmark simply by ranking the number of sponsors competing/bidding for that particular landmark compared to the number of sponsors competing/bidding for other landmarks.

FIG. 2B presents a system 2B00 implementing a possible technique for selecting relevant responses. Of course the system 2B00 can be implemented in any of the contexts of FIGS. 1A-2A. As shown, the operations of FIG. 2B might be executed sequentially, or they might be implemented in parallel, or some combination of sequential or parallel execution. At least the system 2B00 has access to the information on the candidate locations as were prepared in operation 2A40. In some cases the information retrieved in operation 2B10 might be precisely the same candidate information sets as were prepared in operation 2A40. In other cases, the candidate information sets as were prepared in operation 2A40 might be used within another database operation, such as a join or projection. For example, the candidate information sets as were prepared in operation 2A40 might not contain any temporal information such as news items or announcements of some event occurring at or near some geo-location, on some date, or during some duration; however a join or projection could result in such correlations.

As introduced by operation 2B20, a pre-filter might be applied. Indeed, the composition of the candidates might trigger a rule to resolve apparent ties or conflicts (e.g. if there are multiple Bob's Café location in the user's proximity, filter out all except the closest one). A wide range of pre-filtering techniques are possible and envisioned, including sorts and comparisons, and heuristics to eliminate duplicates or ties, or other conflicts. As an example, a sponsor, for instance a liquor distributor might express a desire to be excluded from bid marketplaces resulting from geo-requests received at times and locations coinciding to an anti-drinking demonstration. The sense of any operations to pre-filter can be understood when considering that such a pre-filter operation is at least partially intended to support a sponsor's campaign exclusions—and hence ads in a sponsor campaign that the sponsor intends to be excluded (pre-filtered) are not brought to the spontaneous bidding marketplace. More generally, in some embodiments, advertisers can limit the types or kinds of users for whom they want to compete in auction. To this result, advertisers may designate demographic or other targeting data as an express exclusion, or express limiting factors, or explicitly define qualification/disqualification criteria for certain marketplaces as might be created by incoming user requests. As an example, a coffee shop might set up campaign settings to bid a higher amount during morning and mid-afternoon hours than during lunch hours. And further, campaign settings for a particular location might expressly exclude participation in bidding during hours when the coffee shop at that specific location is closed.

Operation 2B30 serves to submit the candidate and pre-filtered marketplace participants to an auction. Of course, such a keyword or keyphrase auction is well understood. The emphasis of this operation in the context of system 2B00 is merely to indicate that an electronic bidded-keyword and/or bidded-phrase marketplace was formed, an auction held, and at least one winner (or sometimes more, in case of a tie) and possibly a series of runner-ups result from the auction. Similarly, for advertisers with multiple locations within one area, location-specific techniques embodied in the system 2B00 and more generally in the system 1B00 provides an effective way to balance and grow traffic to multiple locations by real-time adjustment of advertising spend in areas with lower actual store traffic.

In some embodiments, the system selects relevant candidates for eventual return to a user by using user profile or user interest profile, or other user data to either pre-filter the list of possible advertisers in the marketplace, or post-re-rank the list based upon user preference or other weighting factors found in the user's data (see operation 2B40). In some cases user data (e.g. user profile, user permissions, user behavior, or any other user-related data) may be used to apply an indicated or inferred a preference for any advertisers within the qualified marketplace over any of the others. In general, an advertiser is eligible for consideration if they satisfy the geo-constraints of the request and are qualified for specific marketplace and time period, and the user's profile data does not disqualify the advertiser.

Typically in traditional online keyword auctions, the ‘best’ location within a particular property is offered for bid at auction, and the winner's advertisements are placed at the ‘best’ location. In some situations, factors beyond monetization are included in placement. In particular, an operation to satisfy a user request for a geo-location service might reasonably include one or more factors other than monetization, such as factors akin to spatial relevance. In fact, in some cases it might be unreasonable or at least not particularly relevant to present certain responses. For example, Bob's Café might be the highest bidder in a particular auction, and from one perspective reasonably so because Bob's Café is located “just across the river”. However, if the user requesting geo-location services is on foot, and the bridge across the river is closed to foot traffic, it is almost certainly irrelevant to the user since the user cannot easily reach Bob's Cafe. It would also almost certainly be irrelevant to the sponsor of Bob's Cafe since the user cannot easily reach Bob's Café, and presentation of an advertisement then and there would be unlikely to result in the desired user action. Of course the foregoing is but one example. More generally, a list of top-bidders and the inherent monetary relevance factors can be combined with other relevance factors intended to result in highly relevant placements within the context of the geo-services application. As shown in operation 2B40, reasonable and envisioned criteria to be considered for ranking/scoring include visibility (e.g. line-of-sight visibility, size/prominence of a sign or address, attention rank, etc), W4 relevance factors, that is who/when/where/what relevance (e.g. social relevance, temporal relevance, spatial relevance, topical relevance), familiarity (e.g. how generally well known is the landmark or labeled location), and additional monetary relevance factors (e.g. How much in absolute terms was the winning bid? How much were the bids of the runners up?, etc.).

The notion of familiarity in the context of a scoring operation transcends the common definition and can be viewed as a model intersecting any or all of social relevance, temporal relevance, spatial relevance, topical relevance. For example, a landmark for which label is known or shared among multiple users in some social grouping, might be ranked as more familiar to that group of users that some label that is not shared. Similarly, the landmark “Sorority House” might be more familiar to students on that campus as compared to “Bank of America ATM”, even though the physical geo-locations returned by the geo-locator system might be identical. Also, from a advertiser's perspective, an advertiser could create campaigns to build awareness or familiarity of the advertiser's brands to a particular landmark, for example, the confection manufacturer “Ghirardelli” has long ago established a campaign to associate the brand name to the location known as “Pier 39”, and such a campaign might be extended to advertising in conjunction with geo-location services. Still further, familiarity of a particular location or landmark can achieve a higher value based on aggregated user data. For example, if many users consistently over time issue a request for “Where are My Friends” from a location commonly known as “Hachiko”, then a system 2C00 might consider the location and label “Hachiko” to be familiar. In other words, people “vote with their feet”, and such behaviors can be used in the context of a ranking/scoring operation.

The notion of visibility in the context of a scoring operation transcends the common definition and can include characteristics simply of absolute visibility (e.g. Eiffel Tower) or a learned visibility (e.g. learned over time based on user behavior), or using 3D models, and/or line-of sight calculations, or using street-level images, or even including attention rank. Temporal information can also affect visibility. For instance, the Christmas Tree at Rockefeller Center is an excellent landmark in a December timeframe, but does not serve as a landmark at other times of the year. Similarly, a lighted neon sign may be an effective landmark during night time or a time when a business is open; a monument may be visible from the highway in the winter when not obscured by foliage; but these aforementioned landmarks might be low scoring or possibly useless landmarks at other times. Additionally brand recognition may affect visibility—twenty foot high golden arches are widely recognized in association with a brand, while a sign for a local cafe may not make the same visible impression even if it a similar size. The audience also matters as to the visibility scoring vis-a-vis brand recognition; a foreign visitor may not have the same brand awareness as locals, and so personal brand or landmark visibility is at least partially a function of past personal experience. For example, a physical spacio-temporal path gathered through a proxy device may show several repeat visits to a specific landmark, location or brand-affiliated location, and this data may be used in the future to increase the weight of these locations as potential responses to that user's request. Landmarks, locations and brands that are contained within or the subject of communications may also influence the personal visibility of that location to that user, so even if a user has not physically visited a location in the past, communications about a location or landmark are still relevant. In some embodiments, the real-time location of other users may also be used to influence visibility by preferencing locations or landmarks well known or near to other users known to the requesting user.

The notion of spatial relevance in the context of a scoring operation transcends the mere notion of distance, and may include a personalized distance. In one embodiment, calculation of a personalized distance between two real-world entities can begin with determining one or more routes between two real-world entities. One or more routes can be chosen based on a user's preferred mode of travel. For example, a person may prefer to walk or use public transportation rather than driving. Routing can simply choose the shortest available route. Routing can additionally reflect further travel preferences, such as avoiding highways, tolls, school zones, construction areas, and so forth. Given a known route, spatial distance can then be determined for the route. In one embodiment, spatial distance is the length of the route. In another embodiment, the time to travel to a destination can be considered a form of spatial distance. Spatial distance can be modified by spatial factors not directly related to distance. Such spatial factors may relate to additional spatial dimensions such as height, altitude, a floor on a building, and so forth. Such factors can relate to physical properties of the route or entities having a location on or near the route. For example, if a person values scenery or visually stimulating surroundings, whether natural, or manmade, a route that has a view of a bay or ocean or skyline can be more desirable. If a portion of a route has a reputation for being in poor physical condition or is under construction, the route can be considered less desirable. Spatial factors may additionally include the additional dimension of velocity (i.e. direction and speed) of a user or other entities. Spatial factors may additionally include environmental conditions tied to physical locations, such as local weather conditions. Spatial distance can then be further modified using temporal factors, social factors, and topical factors.

Temporal factors can be generally defined as factors that relate to how the passage of time affects the desirability of a route and the mode of transportation. The most basic temporal factor is the time it takes to travel a route. Travel time on a route can be estimated based on average travel time historically associated with a route. Alternatively, travel time can be more precisely determined by monitoring average speed and travel times from real-time monitors or sensors. Such sensors can be fixed sensors specifically installed along major avenues of travel for monitoring traffic flow. Such sensors can also be user devices, such as cellular telephones or GPSs whose location is continuously monitored and which can thus be used to determine the speed of travel for individual user devices whose physical position is known. In one embodiment, data used to determine travel time on a route may be a combination of many sources of data from multiple sensor networks. Such travel time can be useful, but can be enhanced by combining it with historical travel time data accumulated over a period of time. For example, on Friday, people may historically leave the office earlier, and traffic predictably suffers a 15 to minute slow down between 6:00 PM and 7:00 PM on major routes out of a city. Thus, the speed of traffic at 5:45 PM may provide an overly optimistic estimate of travel time between 6:00 PM and 7:00 PM for a person whose commute would normally be 30 minutes. Travel time can also be affected by weather conditions. Thus, when it begins to rain, historically, traffic may suffer a 30 minute slow on major routes out of a city. Thus, if rain is predicted or if it just begins to rain, travel time for such routes may be adjusted accordingly. Travel time can also be affected by local events. For example, a concert may be booked at a large arena downtown for a specific date starting at 7:00 PM. Historical data may indicate that traffic slows down in the vicinity of the arena during concerts, increasing commute times by 10 minutes. Temporal factors can additionally include temporal data relating to the starting point and ending points of a route. For example, if the destination of a route is a restaurant or a retail location, if the location closes before the route can be fully traversed, the route is undesirable. If the wait time to be seated at a restaurant exceeds, for example, 30 minutes, the route may also be undesirable. If an event is scheduled to occur at a location at a particular time, for example, live music begins at 10 PM, a route that arrives at the location after 10:00 PM may be undesirable. Temporal factors can additionally include temporal data relating to a specific person. For example, if a person has an appointment, a route that arrives early for the appointment is desirable. If a person typically engages in specific activities at home, such as viewing a specific television program, a route that takes a person to a location away from home, for example, a restaurant, that is so distant that the person will not be able to reach home before the program airs may be undesirable. Thus, the time it takes to traverse a route, informed by real-time and historical data, and the impact of such travel time on cotemporaneous events can be determined for a specific route or a group of routes. Spatial distance, travel time, and events affected by travel time can, in one embodiment, be displayed individually. Alternatively, temporal factors can be used to modify spatial distance to create a personalized distance. The personalized distance reflects the overall desirability of the route. In one embodiment, the distance increases as the desirability of the route decreases. For example, a route that reflects a spatial distance of 10 miles may be increased to 30 miles because of slow travel time or because the route will arrive late for an appointment based on real-time travel estimates. A route which is expressed as a temporal distance of 10 minutes may be increased to 30 minutes or “TL” for too long if the route will arrive late for an appointment based on real-time travel estimates.

The notion of temporal relevance in the context of a scoring operation transcends the mere notion of separation in time. In one embodiment, temporal factors can be used as weighting factors or additive factors that are used to modify spatial distance in a consistent manner. Weighting and additive factors can be used to reflect a simple, continuous numerical relationship. For example, if a 10 mile route is projected to have a travel time of 30 minutes, reflecting an average speed of 20 mph, whereas 60 mph is taken to be an arbitrary target travel speed, a weighted distance of 30 miles could be computed by multiplying the travel time by the target travel speed. In another example, an arbitrary increment of 1 mile can be added to spatial distance for every additional minute a person is projected to be late for an appointment. In another embodiment, a pre-defined code or tag could be associated with the spatial distance, e.g. “IOL” for ten minutes late, or “TL” for too late or too long. Weighting and additive factors can additionally or alternatively, be used reflect a discrete intervals used multiplicatively or additionally. For example, if a person is projected to be late for an appointment from 1 to 10 minutes, a multiplier of 1.5 or an addition of 10 miles could be applied to spatial distance, whereas if a person is projected to be 11-20 minutes late, a multiplier of 10 or an addition of100 miles could be applied to spatial distance. Spatial distance can thus be weighted by temporal factors in a large number of ways to produce a qualitative personal distance that reflects spatial distance of a route and also reflects the impact of temporal factors on the desirability (or even feasibility) of the route. In one embodiment, the exact methodology for combining spatial distance and temporal weighting factors can vary from person to person, and can be customized to reflect the personality or habits of a person. Thus, a person who hates driving may heavily weight travel time, whereas an obsessively punctual person may heavily weight being late for work or appointments. In one embodiment, the user can explicitly input such preferences. In another embodiment, such preferences may be imputed user behavior which is reflected by sensor data and interaction data for the user accumulated over time. Spatial distance can additionally be modified using social factors. Social factors can be generally defined as factors that relate to how a person's social relations may affect the desirability of a route. A route can be considered more desirable if the route is in proximity to one or more individuals who are in a person's social network or otherwise demonstrate a social relation with a user on the basis of spatial, temporal, or topical associations, correlations, overlaps or degrees of separation. Such factors could be based on profile data associated with individuals in a person's social network. For example, a route that passes the home address of a close friend can be considered more desirable, as it offers the potential opportunity to drop in on a friend. Such factors could also be based on dynamic, real time data associated with persons in a social network. For example, a route to a location may be considered more desirable if one or more friends or acquaintances are currently present at that location.

The notion of social relevance in the context of a scoring operation transcends merely interpersonal connections. Social factors may also make use of interaction or transaction data associated with individuals in a person's social network. For example, a route to a location may be considered more desirable if the location is a business which is frequented or favorably reviewed by one or more friends or relatives. In another example, a route containing roads that have been unfavorably commented on by friends or are habitually avoided by friends can be considered less desirable. Social network factors can also be used in a negative fashion as well. Thus, if an individual is identified within a person's social network as a person to be avoided, routes that tend to avoid the individual and businesses and locales frequented by the individual may be considered preferable.

The notion of topical relevance in the context of a scoring operation transcends merely storing and comparing keywords. Topical factors can be generally defined as including factors that relate to known information associated with locations, users, and other entities in the environment. Such factors can relate to how a person's interests and preferences, as well as external events, affects the desirability of a route. For example, topical factors may relate to the general area surrounding the route. For if a person is safety conscious, a route that passes through an area that has a high crime rate can be considered less desirable. If a person enjoys shopping for haute couture, a route that passes through an area that has a high density of high end retailers or boutiques may be more desirable. Topical factors may relate to events occurring on or in the vicinity of the route. For example, if a festival is occurring in a neighborhood, a route that passes through the neighborhood may be more or less desirable, depending on whether a person has an interest in the festival or not. Topical factors may relate to the destination of the route. For example, a route to a location may be considered more desirable if the location is a business which is associated with a topic of interest (or aversion) to the user. For example, if a person is a fan of blues music, a route to a destination associated with blues music (i.e. a blue's club) can be considered more desirable. In another example, if a person doesn't like children, a route to a destination that is rated as a great family destination can be considered less desirable. A route to a location may be considered more desirable if the location is a business which is favorably reviewed by a favorite reporter or news publication or a friend. For example, a route to a restaurant which has received glowing reviews in local publications can be considered more desirable, but may be less desirable if a user's best friend gives the restaurant a bad review. Topical factors can thus be weighted by any known social factor related to the topic. In one embodiment, social and topical factors can be used in addition to temporal factors as weighting factors or additive factors that are used to modify spatial distance in a consistent manner to produce a personalized distance. In one embodiment, the exact methodology for combining spatial distance and temporal weighting factors can vary from person, and can be customized to reflect the personality, habits, and preferences of a person. Note that the methodologies described above can be extended to determine a personalized distance which is not tied to a physical route, or even to spatial or temporal dimensions. In one embodiment, the route is a straight line between the starting location and the ending location, a relative distance from a central third point, or a calculation based on a cluster of locations, and can be adjusted by social and topical factors.

In addition to the aforementioned technique involving scoring, the matching of advertisers to user geo-location service requests can also be accomplished without a real-time bidding marketplace, but instead is based upon some time delimited, fixed-price period of sponsorship. Such a style of sponsorship has the effect of creating virtual territories around actual locations with accompanying variance in economic terms for requests coming from those locations or adjacent areas.

Still other embodiments of the system 2B00 leverage the fact that location sensing technology has limited precision, and that reverse geo-coding (i.e. translating a latitude and longitude coordinates to a street address) is often even less precise. That is, given such limitations it is often more correct (if merely less precise) to say that a user is near (as opposed to at) a given location. Thus, advertisers might include in their bid some specifications of incrementally higher bids based on the appropriate prepositional phrase. That is, pushing an advertisement to a coffee drinker who is “directly in front of Bob's Café” is more likely to result in the desired user response than reaching pushing an advertisement to a user who is “on the opposite side of the mall from Bob's Café”. Accordingly the sponsor of Bob's Café might bid higher for a label using the prepositional phrase “directly in front of” as compared to a label using the prepositional phrase “on the opposite side of the mall”.

Again referring to FIG. 2B, the operation 2B50 serves to select a group of ranked candidates to present to the requesting user. It should be noted that different devices (e.g. cell phone, a 4-line LCD screen device, a cell phone with a VGA display, a smart phone with a touch screen, a mobile PC, etc) each have different characteristics that make display of multiple placements easier/harder. The operation 2B50 serves to select the ranked candidate placements to correspond to the display characteristics of the user's device.

Returning to FIG. 1B, specifically the operation 1B40, it may be understood to those skilled in the art that modern techniques to return relevant responses to the requesting user considers many variables, many of which are known in the art. As such operation 1B40 may be expanded to include any number of techniques used in online placement of advertisements, including dynamic composition of advertisements. Of course, even though a particular advertiser becomes the highest bidder in an auction for placement, in some embodiments it still remains to select from among a group of advertisements to be placed. In fact, the copy and form of some advertisements are created dynamically on the basis of keywords, or other relevance factors. The extensions included in presenting copy or advertisements or other sponsored information in the context of a response to a user's geo-location request might include advertiser's desired labels as may be applied to a particular location. A label might be as simple and direct as the common name for a landmark (e.g. “Empire State Building”) or it might be a sponsor's name (e.g. “Bob's Café”), or a label might be in the form of a prepositional phrase (e.g. “You are near the best burgers in the city—Bob's Café”), or a label might be in the form of a cross-promotional phrase (e.g. “You are near the best burgers and desserts in the city—Just Desserts located inside Bob's Café”, or “Visit Diamond Jim's Supper Club—next to the movie theatre” ), or a label might be a user-defined label for a particular geo-location point and some zone of uncertainty (e.g. near “My House”, or in front of “My Nephew's Apartment”). In still more embodiments, a label might have the form of an icon, or an image, or a video, or a sound, or any other media, possibly including real-time data (e.g. satellite feed or street-level feed).

The foregoing paragraphs have exemplified immovable locations as landmarks. However, it is reasonable and envisioned that geo-locations of moving objects or persons be reported to a user. For example, in response to a geo-location query in the form of “Where are my friends”, the service might return, “Cindy is at Bob's Café”, or “Tony is near Coit Tower”. Of course, ranking social relevance factors might be particularly important in such an embodiment.

Continuing with this embodiment, the path over time of a person or moving object might be tracked over time periodically, or even under a scheme of continuous tracking, and thus a geo-location service could respond to a user's request to know “When will Tony arrive”. Given this level of information and inference, an advertiser could suggest “Do you need anything from the Grocery Store—Tony is there now”. Still further, given this level of information and inference, an advertiser could suggest meeting locations and per-event promotions, as in “Why not meet at Bob's Café, where Cindy is now. Tony can be there in 3 minutes”, and might even include in the response a “Get a coupon for a beverage at Bob's Café”. In variants, the aforementioned coupon might be pushed to the user's device, or a link might be provided for the user to pull on demand. Of course, such suggestions such as “Tony can be there in 3 minutes” make assumptions or inferences about mode of travel. Similarly techniques used herein might consider exertion as well as distance. For example, it would take a person 5 minutes to walk from “point A” to “the top of Coit Tower”, but only 2 minutes to walk from “the top of Coit Tower” to “point A”.

FIG. 2C presents a system 2C00 implementing a possible technique for returning relevant responses to a user. Of course the system 2C00 can be implemented in any of the contexts of FIGS. 1A-2B. The operations of FIG. 2C might be executed sequentially, or they might be implemented in parallel, or some combination of sequential or parallel execution. As shown, system 2C00 might begin by constructing one or more advertisements as selected in the operation to select a group of ranked candidates 2B50. Of course as indicated in the foregoing paragraphs, any of various known techniques might be used to create advertisement copy. Additionally, or possibly instead of presenting the aforementioned advertising copy to the requesting user, an operation to construct labels 2C20 might be invoked. The operation to construct labels is shown and discussed separately from the operation to construct advertisements, however a strong distinction between advertising copy and labels is not necessary for the understanding of the embodiments presented herein. In fact some embodiments co-mingle any number of labels with any number of advertisements or sponsored labels. As an example, in response to a user request for a geo-location service to help navigate (e.g. “how do I get from here to Thai Food”), the system 2C00 might construct a response, “Go one block west, past Bob's Café, then two more blocks to Thai Food. If you get to City Park you have gone too far”. Of course, any or all of “Bob's Café”, “Thai Food” and/or “City Park” could be sponsored and competing sponsors for the location could be resolved by real-time auction. Of course, creating directions or even merely a route list for a user might include biasing toward use of more visible landmarks, or use of familiar landmark route paths, or might include even slightly longer paths, or stair-step paths based on possible inclusion of one or more sponsored landmarks.

Continuing, the system 2C00 assembles some combination of advertisements and labels in operation 2C30. The selection of an appropriate combination of labels and advertisements might be as simple as selecting from among the first (prioritized) set of results to return and retuning only those within some limit (e.g. byte count limit, user preference limit, etc.) which limit may be associated with the user's device or associated with the user's profile, or other user data. Or, the operation to assemble advertisements and labels 2C30 might perform some association between an advertisement and a label (or a label and an advertisement) and return results accordingly. For example, in response to a user's request for a geo-location service, the system 2C00 might return, “You are near Coit Tower—Brought to you by the SF Port Authority”. In the preceding example, the label portion is “You are near Coit Tower”, and the advertisement portion is “Brought to you by the SF Port Authority”. Of course both labels and advertisement can be merely text, or could be any other image or media, or could be return to be presented to the user separately, for example, the results returned to the user might include, “You are near Coit Tower” and might also include a photo of Coit tower taken from general proximity of the user's geo-location. In the context of a geo-location service, it is possible that the service might have information on a particular geo-location (e.g. “You are near Coit Tower”) but not have any corresponding sponsor for that location. Even in such a case of a location that does not have sponsorship (at that moment in time) the user would still expect the geo-location service to return useful results. Accordingly, the system 1B00, and more specifically the system 2C00 support both sponsored landmark labeling and non-sponsored landmark labeling.

In another embodiment of system 2C00, delivery of labels consisting solely of common names (e.g. “Coit Tower”) as landmark labels might be reasonably omitted from a result set in preference for a sponsored location label (e.g. “Bob's Café at Coit Tower”, “The Best Thai Food near Coit Tower”). In yet another embodiment of the system 2C00, labels might be constructed by using relative or aliased labels, or user-aliased labels as may be identified by a user or by a cohort of users. For example, a label for a landmark with common name “The James Goodhand Memorial Field” might be constructed from a user-aliased label such as “Shannon's soccer field” (referring to the user's daughter, Shannon), or from an user-aliased label constructed by inference or concatenation (e.g. “You are 300 feet from the Starbucks near Shannon's soccer field”). These user-aliased labels could be constructed from explicit user input (e.g. a user inputs their “home” location or tags a photo from a given location as “Shannon's soccer field”) or could be inferred from data over time (e.g. “home” can be inferred from the location a user spends most nights, “Joe's office” can be inferred from the location where Joseph Smith spends most days 9:00 to 5:00 and the label “Joe” could be learned as an appropriate label for Joseph Smith from the address book labels applied by a given user.) Labels may also be applied via audio or visual recording such as a media clip associated with a landmark or location, and may be associated with a text label or themselves be the label.

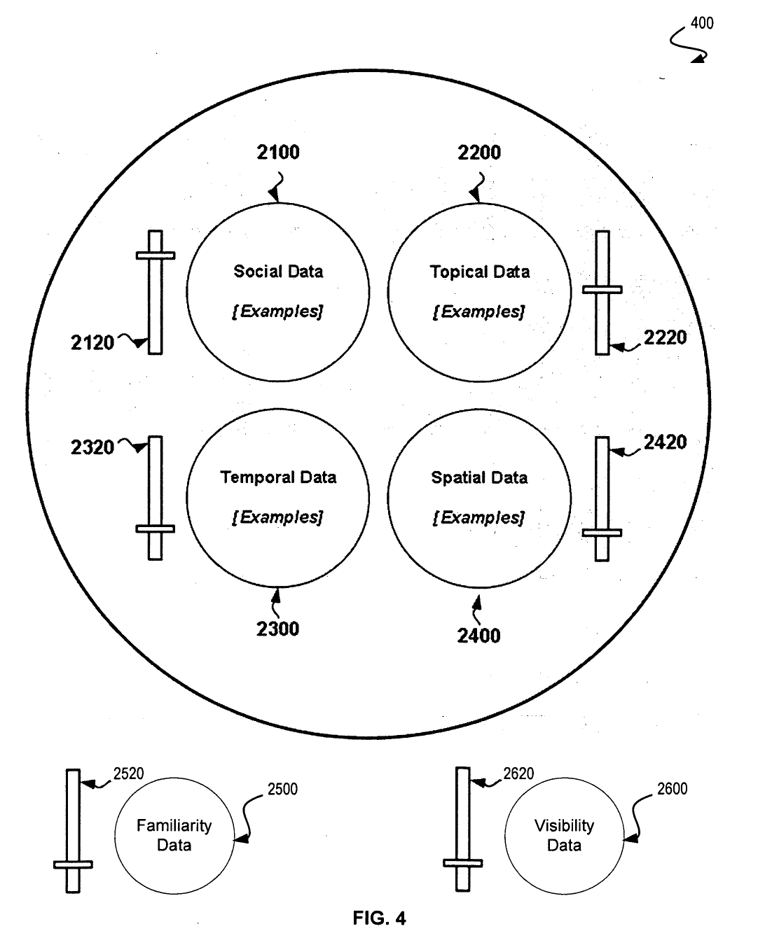

FIG. 2D presents a system 2D00 implementing a possible technique for assembling advertisements and labels to a user. Of course the system 2D00 can be implemented in any of the contexts of FIGS. 1A-2C. The operations of FIG. 2D might be executed sequentially, or they might be implemented in parallel, or some combination of sequential or parallel execution. At least, the system 2D00 serves to apply a post-ranking algorithm to a list of candidate responses. As shown, operation 2D10 establishes differential weighting for a set of relevance factors (see FIG. 4). In addition to the differential weights applied to specific relevance factors, a user might set preferences or differential weights along a continuum reflecting the user's bias toward any number of factors including but not limited to use of more common or branded names, use of more personalized names and aliased labels for locations. A user expressing preferences for using such branded names might become a candidate for a target group in a cost per action (CPA) advertising campaign in which the user can be incented to perform actions consistent with a brand's CPA campaign (e.g. convincing friends to meet at Starbucks instead of Joe's Café next door). Or more generally, a user can be incented to perform actions consistent with a brand's CPA campaign, possibly including a hierarchy of multiple independent tasks or multiple dependent tasks (e.g. buying a watch at Costco and buying a futon at Costco). In other embodiments, the notion of a cost per action might take advantage of the mobile nature of the user and the user's terminal. Strictly as an example, the age-old “Two for One” promotion (e.g. two mocha java cappuccino servings for the price of one) becomes much more relevant for both the advertiser and for the consumer when a person (e.g. a friend who is in the same vicinity) needed to take advantage of the promotion can be identified by a geo-service request and coordinated through personalized communications and instructions in order to satisfy a commercial incentive or other advertiser's conditions for a promotion or campaign.

Again referring to operation 2D10, such differential weights and preferences might be used in the calculations and rule application operations 2D20, 2D30, and 2D40. In some embodiments, the familiarity relevance factor is automatically increased to bias selection of labels that have higher familiarity, even before applying scoring based on non-familiarity relevance factors. Further, considering techniques for applying heuristics and using differential weights to factors, an advertiser might sponsor a cross-promotion based on the visibility or familiarity of a landmark. For example, a hard-to-find hardware store might sponsor a promotion using a label such as, “Bing's Hardware Store—located across from Carnegie Hall”, where the landmark label “Carnegie Hall” was selected from among all other proximally co-located landmarks due to a high ranking in the visibility dimension. As another example including construction of a response to a user involving visibility criteria, specifically line-of-sight visibility criteria, in response to a user request from say, street-level on the Embarcadero, a request for directions to “Ghirardelli Factory” might return, “Proceed north to Pier 39” rather than “Proceed north to the Ghirardelli sign”, since the visibility from street level on the Embarcadero of Pier 39 is far greater than the visibility of the Ghirardelli sign (even though the Ghirardelli sign is highly visible from proximal co-locations on the water).

Operation 2D20 and 2D30 apply quantitative and rule-based techniques to filter and rank the group of candidates. Of course ranking in W4-space, or ranking in any N-space possibly including W4-space is understood in the literature as generating N-space vectors and taking distances between vectors to result in quantitative measures. Similarly, application of rule-based techniques 2D30 serve to bias or even override the quantitative measures. In some cases, some of the quantitative measurements are performed before applying heuristics, hence the generalized system 2D00 includes taking quantitative measurements both before and after application of heuristics.

Given a quantitatively ranked list of candidates (resulting from operations 2D20, 2D30, 2D40) the list of candidates can then be post-ranked and filtered in operation 2D50 so as to return a post-filtered list. This operation might include filtering of identical or marginally different candidates.

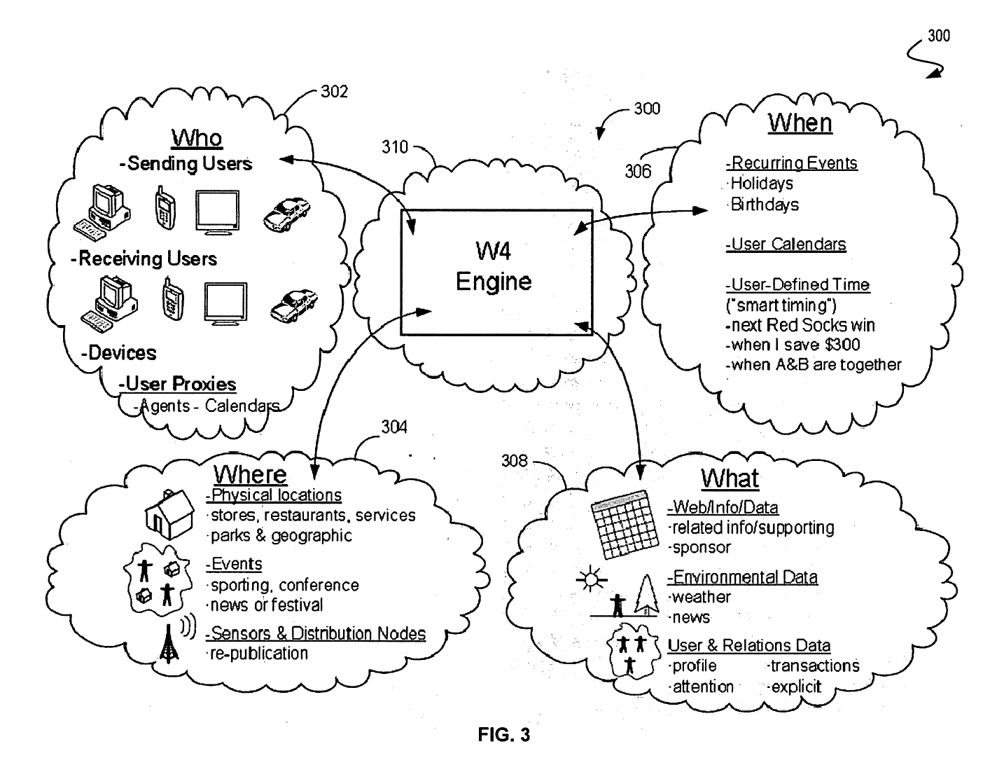

FIG. 3 expands on the relevance factors that might be used in a ranking operation (for example the ranking operation of 2B40), and introduces a possible embodiment of a system including an engine adapted to return relevance information, including “Who”, “When”, “Where”, and “What” relevance. The system 300 creates an instrumented messaging infrastructure in the form of a global logical network cloud conceptually sub-divided into networked-clouds for each of the 4Ws: Who, Where, What and When. In the Who cloud 302 are all users whether acting as senders, receivers, data points or confirmation/certification sources as well as user proxies in the forms of user-program processes, devices, agents, calendars, etc. In the Where cloud 304 are all physical locations, events, sensors or other RWEs associated with a spatial reference point or location. The When cloud 306 is composed of natural temporal events (that is events that are not associated with particular location or person such as days, times, seasons) as well as collective user temporal events (holidays, anniversaries, elections, etc.) and user-defined temporal events (birthdays, smart-timing programs). The What cloud 308 is comprised of all known data—web or private, commercial or user—accessible to the system 300, including for example environmental data like weather and news, RWE-generated data, an information object (“IO”, or “IOs”) and IO data, user data, models, processes and applications. Thus, conceptually, most data is contained in the What cloud 308. Some entities, sensors or data may potentially exist in multiple clouds either disparate in time or simultaneously. Additionally, some IOs and RWEs can be composites in that they combine elements from one or more clouds. Such composites can be classified as appropriate to facilitate the determination of associations between RWEs and IOs. For example, an event consisting of a location and time could be equally classified within the When cloud 306, the What cloud 308 and/or the Where cloud 304. The W4 engine 310 controls all interactions between each layer of the system 300 and is responsible for executing any approved user or application objective enabled by system 300 operations or interoperating applications. In an embodiment, the system 300 is an open platform with standardized, published APIs for requesting (among other things) synchronization, disambiguation, user or topic addressing, access rights, prioritization or other value-based ranking, smart scheduling, automation and topical, social, spatial or temporal alerts. One function of the system 300 is to collect data concerning all communications and interactions conducted via the system 300, which can include storing information in objects and storing other information identifying landmarks, business, or any other real-world entities including corresponding relevance information (e.g., who, what, when, where information). Other data collected by the system 300 can include information about the status of any given real-world entity at any given time, such as the location, operational state, monitored conditions (e.g., for an real-world entity that is a weather sensor, the current weather conditions being monitored or for an real-world entity that is a cell phone, its current location based on the cellular towers it is in contact with) and current status. The function of identifying real-world entities associated with or implicated by its information and/or actions performed by other real-world entities may be referred to as entity extraction. Entity extraction can include both simple actions, such as identifying the sender and receivers of a particular information object, and more complicated analyses of the data collected by and/or available to the system 300, for example determining that a message listed the time and location of an upcoming event and associating that event with the sender and receiver(s) of the message based on the context of the message or determining that a real-world entity is stuck in a traffic jam based on a correlation of the real-world entities location with the status of a co-located traffic monitor. In the embodiment shown, the W4 engine 310 can be one or a group of distributed computing devices, such as general-purpose personal computers (PCs) or purpose built server computers, connected to the system 300 by communication hardware and/or software. Such computing devices can be a single device or a group of devices acting together. Computing devices can be provided with any number of program modules and data files stored in a local or remote mass storage device and local memory (e.g., RAM) of the computing device. For example, as mentioned above, a computing device can include an operating system suitable for controlling the operation of a networked computer, such as the WINDOWS XP or WINDOWS SERVER operating systems from MICROSOFT CORPORATION. Some real-world entities can also be computing devices such as, without limitation, smart phones, web-enabled appliances, PCs, laptop computers, and personal data assistants (PDAs). Computing devices can be connected to one or more communications networks such as the Internet, a publicly switched telephone network, a cellular telephone network, a satellite communication network, a wired communication network such as a cable television or private area network. Computing devices can be connected any such network via a wired data connection or wireless connection such as a wi-fi, a WiMAX (802.36), a Bluetooth or a cellular telephone connection. Local data structures can be stored on a computer-readable medium (not shown) that is connected to, or part of, any of the computing devices described herein including the W4 engine 310. For example, in one embodiment, the data backbone of the system 300, discussed below, includes multiple mass storage devices that maintain information objects, metadata and data necessary to determine relationships between real-world entities and information objects as described herein.

FIG. 4 shows an interface 400 which might be used to apply differential weights to any/all of the W4 factors, and/or any other factors. Referring once again to operation 2B40, and in particular, in the context of an advertising campaign, an advertiser or advertiser's advertising campaign manager might want to influence the ranking/scoring algorithm of operation 2B40. Accordingly and as shown, the interface 400 can be used to apply differential weights to their corresponding visibility factors 2600, familiarity factors 2500, spatial factors 2400, temporal factors 2300, topical factors 2200, and social factors 2100, using sliders 2620, 2520, 2420, 2320, 2220, and 2210.

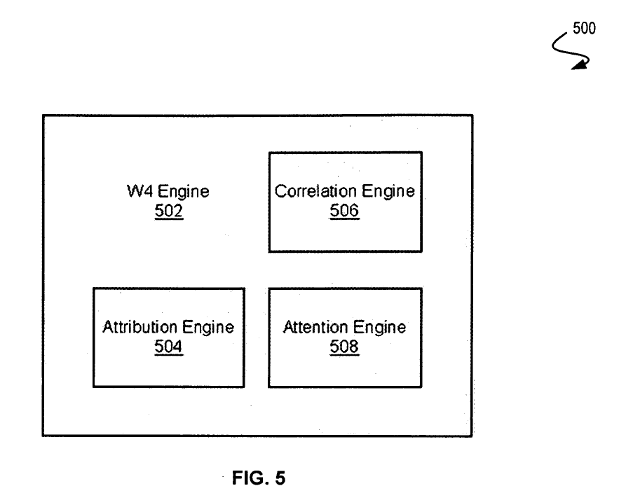

FIG. 5 shows a possible architecture of an embodiment the W4 engine wherein the W4 Engine 502 connects, interoperates, and instruments all network participants through a series of sub-engines that perform different operations in the entity extraction process. The attribution engine 504 tracks the real-world ownership, control, publishing or other conditional rights of any RWE in any IO. Whenever a new IO is detected by the W4 engine 502, e.g., through creation or transmission of a new message, a new transaction record, a new image file, etc., ownership is assigned to the IO. The attribution engine 504 creates this ownership information and further allows this information to be determined for each IO known to the system 500. The correlation engine 506 can operate in two capacities: first, to identify associated RWEs and IOs and their relationships (such as by creating a combined graph of any combination of RWEs and IOs and their attributes, relationships and reputations within contexts or situations) and second, as a sensor analytics pre-processor for attention events from any internal or external source. In one embodiment, the identification of associated RWEs and IOs function of the correlation engine 506 is done by graphing the available data, using, for example, one or more histograms. By selecting each IO, RWE, and other known parameters (e.g., times, dates, locations, etc.) as different bins of the histogram and mapping the available data, relationships between RWEs, IOs and the other parameters can be identified. A histogram of all RWEs and IOs is created, from which correlations based on the graph can be made. As a pre-processor, the correlation engine 506 monitors the information provided by RWEs in order to determine if any conditions are identified that can trigger an action on the part of the W4 engine 502. For example, if a delivery condition has been associated with a message, when the correlation engine 506 determines that the condition is met, it can transmit the appropriate trigger information to the W4 engine 502 that triggers delivery of the message. The attention engine 508 instruments all appropriate network nodes, clouds, users, applications or any combination thereof and includes close interaction with both the correlation engine 506 and the attribution engine 504.

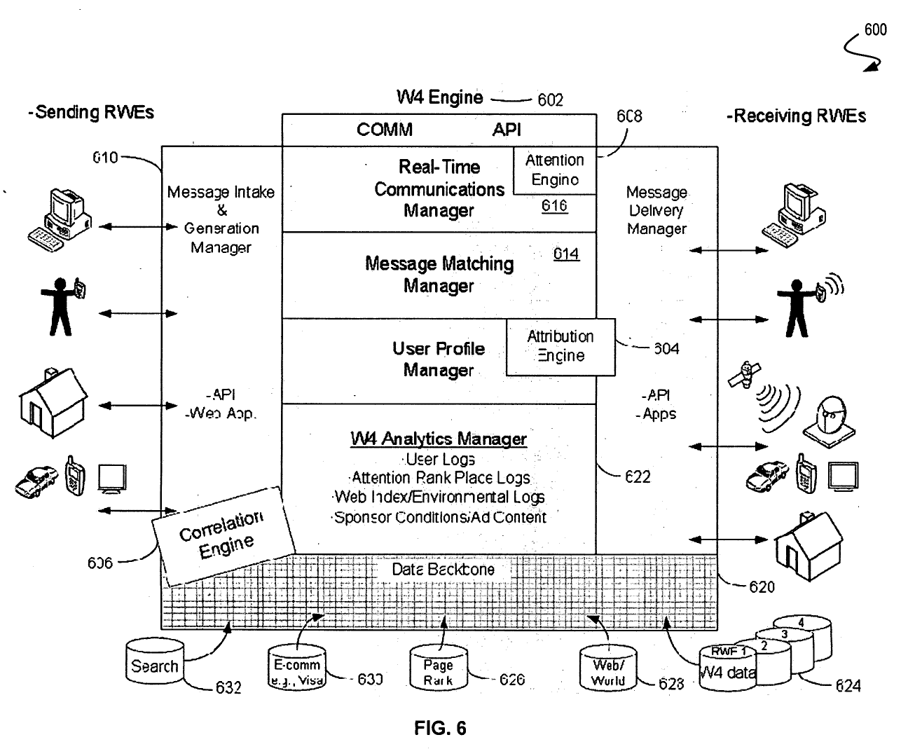

FIG. 6 illustrates one embodiment of a W4 engine showing different components within the sub-engines described above with reference to FIG. 5. In one embodiment the W4 engine 602 includes an attention engine 608, attribution engine 604 and correlation engine 606 with several sub-managers based upon basic function. The attention engine 608 includes a message intake and generation manager 610 as well as a message delivery manager 612 that work closely with both a message matching manager 614 and a real-time communications manager 616 to deliver and instrument all communications across the system 600. The attribution engine 604 works within the user profile manager 618 and in conjunction with all other modules to identify, process/verify, and represent ownership and rights information related to RWEs, IOs and combinations thereof. The correlation engine 606 dumps data from both of its channels (sensors and processes) into the same data backbone 620 which is organized and controlled by the W4 analytics manager 622. The data backbone 620 includes both aggregated and individualized archived versions of data from all network operations including user logs 624, attention rank place logs 626, web indices and environmental logs 618, e-commerce and financial transaction information 630, search indexes and logs 632, sponsor content or conditionals, ad copy and any and all other data used in any process, IO or event. Because of the amount of data that the system 600 will potentially store, the data backbone 620 includes numerous database servers and data stores in communication with the system 600 to provide sufficient storage capacity. The data collected by the system 600 includes spatial data, temporal data, RWE interaction data, IO content data (e.g., media data), and user data including explicitly provided and deduced social and relationship data. Spatial data can be any data identifying a location associated with an RWE. For example, the spatial data can include any passively collected location data, such as cell tower data, global packet radio service (GPRS) data, global positioning service (GPS) data, WI-FI data, personal area network data, IP address data and data from other network access points, or actively collected location data, such as location data entered by the user.

Temporal data is time based data (e.g., time stamps) that relate to specific times and/or events associated with a user and/or the electronic device. For example, the temporal data can be passively collected time data (e.g., time data from a clock resident on the electronic device, or time data from a network clock), or the temporal data can be actively collected time data, such as time data entered by the user of the electronic device (e.g., a user maintained calendar). Logical and IO data refers to the data contained by an IO as well as data associated with the IO such as creation time, owner, associated RWEs, when the IO was last accessed, etc. For example, an IO may relate to media data. Media data can include any data relating to presentable media, such as audio data, visual data, and audiovisual data. Audio data can be data relating to downloaded music, such as genre, artist, album and the like, and includes data regarding ringtones, ring-backs, media purchased, playlists, and media shared, to name a few. The visual data can be data relating to images and/or text received by the electronic device (e.g., via the Internet or other network). The visual data can be data relating to images and/or text sent from and/or captured at the electronic device. Audiovisual data can be data associated with any videos captured at, downloaded to, or otherwise associated with the electronic device. The media data includes media presented to the user via a network, such as use of the Internet, and includes data relating to text entered and/or received by the user using the network (e.g., search terms), and interaction with the network media, such as click data (e.g., advertisement banner clicks, bookmarks, click patterns and the like). Thus, the media data can include data relating to the user's RSS feeds, subscriptions, group memberships, game services, alerts, and the like. The media data can include non-network activity, such as image capture and/or video capture using an electronic device, such as a mobile phone. The image data can include metadata added by the user, or other data associated with the image, such as, with respect to photos, location when the photos were taken, direction of the shot, content of the shot, and time of day, to name a few. Media data can be used, for example, to deduce activities information or preferences information, such as cultural and/or buying preferences information. Relationship data can include data relating to the relationships of an RWE or IO to another RWE or IO. For example, the relationship data can include user identity data, such as gender, age, race, name, social security number, photographs and other information associated with the user's identity. User identity information can also include e-mail addresses, login names and passwords. Relationship data can further include data identifying explicitly associated RWEs. For example, relationship data for a cell phone can indicate the user that owns the cell phone and the company that provides the service to the phone. As another example, relationship data for a smart car can identify the owner, a credit card associated with the owner for payment of electronic tolls, those users permitted to drive the car and the service station for the car. Relationship data can also include social network data. Social network data includes data relating to any relationship that is explicitly defined by a user or other RWE, such as data relating to a user's friends, family, co-workers, business relations, and the like. Social network data can include, for example, data corresponding with a user-maintained electronic address book. Relationship data can be correlated with, for example, location data to deduce social network information, such as primary relationships (e.g., user-spouse, user-children and user-parent relationships) or other relationships (e.g., user-friends, user-co-worker, user-business associate relationships). Relationship data also can be utilized to deduce, for example, activities information. Interaction data can be any data associated with user interaction of the electronic device, whether active or passive. Examples of interaction data include interpersonal communication data, media data, relationship data, transactional data and device interaction data, etc. Interaction data includes communication data between any RWEs that is transferred via the system 600. For example, the communication data can be data associated with an incoming or outgoing short message service (SMS) message, email message, voice call (e.g., a cell phone call, a voice over IP call), or other type of interpersonal communication related to an RWE. Communication data can be correlated with, for example, temporal data to deduce information regarding frequency of communications, including concentrated communication patterns, which can indicate user activity information. The interaction data can also include transactional data. The transactional data can be any data associated with commercial transactions undertaken by or at the mobile electronic device, such as vendor information, financial institution information (e.g., bank information), financial account information (e.g., credit card information), merchandise information and costs/prices information, and purchase frequency information, to name a few. The transactional data can be utilized, for example, to deduce activities and preferences information. The transactional information can also be used to deduce types of devices and/or services the user owns and/or in which the user can have an interest. The interaction data can also include device or other RWE interaction data. Such data includes both data generated by interactions between a user and a RWE on the system 600 and interactions between the RWE and the system 600. RWE interaction data can be any data relating to an RWE's interaction with the electronic device not included in any of the above categories, such as habitual patterns associated with use of an electronic device data of other modules/applications, such as data regarding which applications are used on an electronic device and how often and when those applications are used.

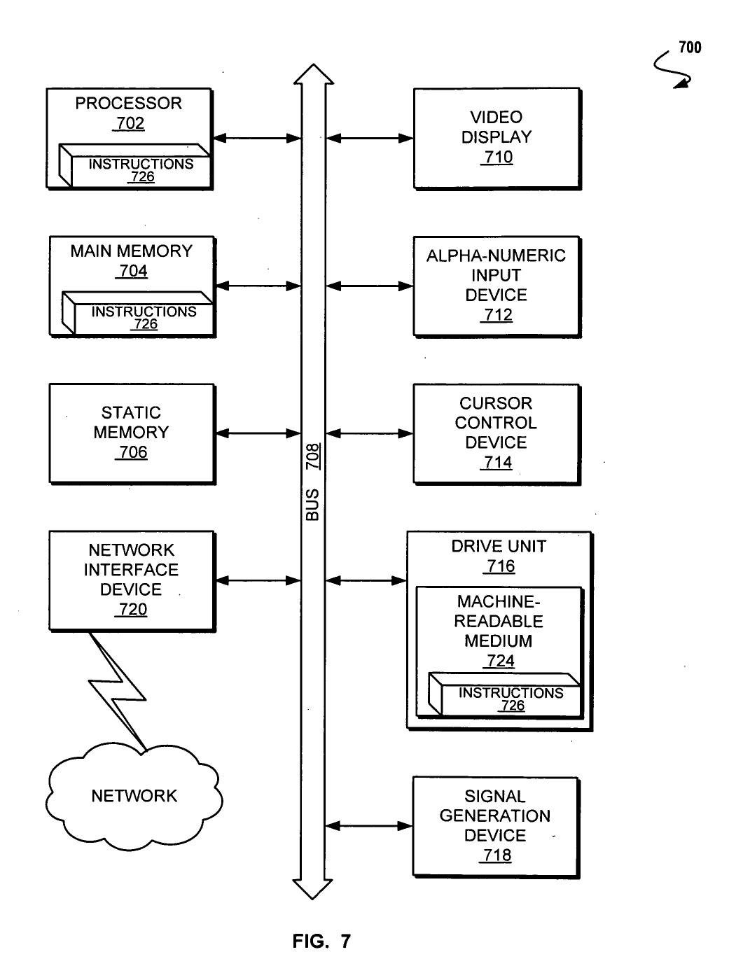

FIG. 7 shows a diagrammatic representation of a machine in the exemplary form of a computer system 700 within which a set of instructions, for causing the machine to perform any one of the methodologies discussed above, may be executed. The embodiment shown is purely exemplary, and might be implemented in the context of one or more of FIG. 1 through FIG. 6. In alternative embodiments, the machine may comprise a network router, a network switch, a network bridge, a Personal Digital Assistant (PDA), a cellular telephone, a web appliance or any machine capable of executing a sequence of instructions that specify actions to be taken by that machine.

The computer system 700 includes a processor 702, a main memory 704 and a static memory 706, which communicate with each other via a bus 708. The computer system 700 may further include a video display unit 710 (e.g., a liquid crystal display or a cathode ray tube). The computer system 700 also includes an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 includes a machine-readable medium 724 on which is stored a set of instructions (i.e., software) 726 embodying any one, or all, of the methodologies described above. The software 726 is also shown to reside, completely or at least partially, within the main memory 704 and/or within the processor 702. The software 726 may further be transmitted or received via the network interface device 720 over the network.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

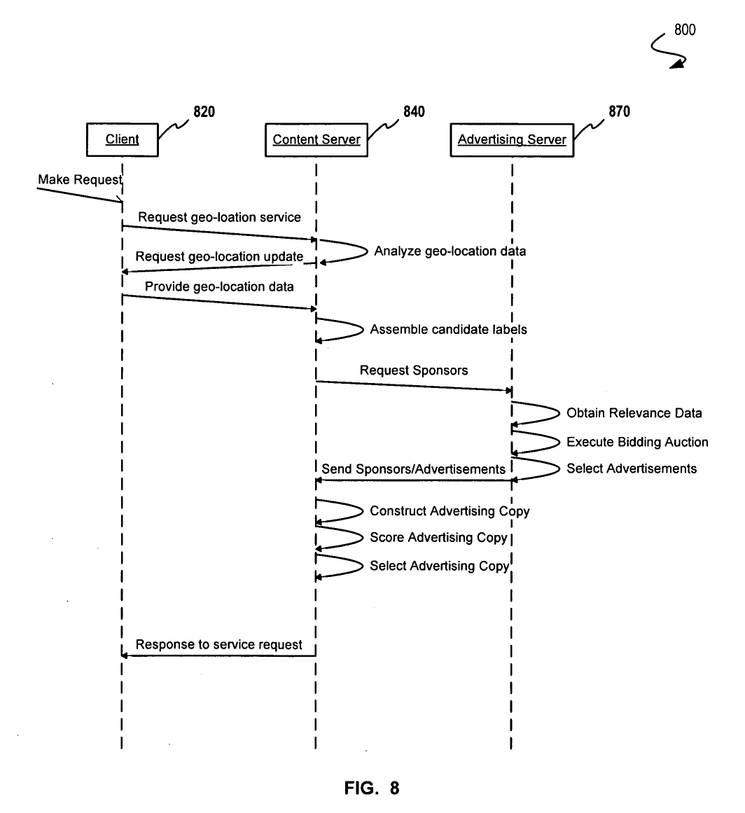

FIG. 8 is a diagrammatic representation of several computer systems (i.e. client, content server, advertising server) in the exemplary form of a client server network 800 within which environment a communication protocol may be executed. The embodiment shown is purely exemplary, and might be implemented in the context of one or more of FIGS. 1 through 7. As shown, the client 820 is capable of initiating a communication protocol by making a request. Such a request might be satisfied solely by a content server 840, or it might be satisfied by a content server 840 and any number of additional content servers or advertising servers 870 acting in concert. In general, any server might be capable of obtaining various forms of relevance data, executing a bidding auction (possibly in conjunction with other servers, not shown) and/or sending selected advertisements to another server. Also, the operations for analyzing geo-location data, assembling candidate labels, obtaining relevance data, executing a bidding auction, selecting advertisements, constructing advertising copy, scoring advertising copy, and selecting advertising copy might execute on any server, and the decision as to which server, and at what relative time in the communication protocol is a matter of convenience; thus any server (or client for that matter) can operate to perform any of the aforementioned tasks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for constructing one or more geo-location service replies based on landmark-related relevance factors to serve to a client system, the method comprising:
receiving a user geo-location service request;
constructing one or more response candidates to said user geo-location service request based on said relevance factors;
scoring said one or more response candidates; and
storing at least one of said response candidates.

2. The method of claim 1 wherein, said constructing includes at least one of monetary relevance, visibility relevance, familiarity relevance, spatial relevance, temporal relevance, social relevance, topical relevance.

3. The method of claim 1 wherein, said constructing includes using bid phrases from an electronic auction.

4. The method of claim 1 wherein, said constructing includes constructing at least one label.

5. The method of claim 1 wherein, said constructing includes constructing at least one route description.

6. The method of claim 1 wherein, said scoring includes at least one of monetary relevance, visibility relevance, familiarity relevance, spatial relevance, temporal relevance, social relevance, topical relevance.

7. The method of claim 4 wherein, said constructing includes at least one of, common name label, a user-aliased label, a sponsored label, a text label, a photo label, an audio label, a video label, a media label, a cross-promotion label.

8. The method of claim 5 wherein said constructing includes at least one of, a turn-by-turn route list, a familiar landmark route list, a sponsored landmark route list.

9. The method of claim 1 wherein, said storing includes storing in at least one of, a memory of a computer, a cache, a non-volatile medium, a message passed over a bus, a message passed over a network.

10. The method of claim 1 wherein, said storing includes storing a time stamp.

11. A system for implementing a method for constructing one or more geo-location service replies based on landmark-related relevance factors to serve to a client system, the method comprising:
receiving a user geo-location service request;
constructing one or more response candidates to said user geo-location service request based on said relevance factors;
scoring said one or more response candidates; and
storing at least one of said response candidates.

12. The system of claim 11 wherein, said constructing includes at least one of monetary relevance, visibility relevance, familiarity relevance, spatial relevance, temporal relevance, social relevance, topical relevance.

13. The system of claim 11 wherein, said constructing includes using bid phrases from an electronic auction.

14. The system of claim 11 wherein, said constructing includes constructing at least one label.

15. The system of claim 11 wherein, said constructing includes constructing at least one route description.

16. The system of claim 11 wherein, said scoring includes at least one of monetary relevance, visibility relevance, familiarity relevance, spatial relevance, temporal relevance, social relevance, topical relevance.

17. The system of claim 14 wherein, said constructing includes at least one of, common name label, a user-aliased label, a sponsored label, a text label, a photo label, an audio label, a video label, a media label, a cross-promotion label.

18. The system of claim 15 wherein said constructing includes at least one of, a turn-by-turn route list, a familiar landmark route list, a sponsored landmark route list.

19. The system of claim 11 wherein, said storing includes storing in at least one of, a memory of a computer, a cache, a non-volatile medium, a message passed over a bus, a message passed over a network.

20. A computer program product embodied on a tangible computer readable medium comprising computer code for executing the steps of:
receiving a user geo-location service request;
constructing one or more response candidates to said user geo-location service request based on said relevance factors;
scoring said one or more response candidates; and
storing at least one of said response candidates.
